(19) United States
(12) Patent Application Publication
(10) Pub. No.: US 2015/0191044 A1
(43) Pub. Date: Jul. 9, 2015

(54) BEARING MODULE

(71) Applicant: JTEKT CORPORATION, Osaka-shi, (JP)

(72) Inventors: Yuya INOUE, Nagaokakyo-shi (JP); Shinji YAMANE, Kashiba-shi (JP); Chiyoko FURUTA, Yamatotakada-shi (JP)

(21) Appl. No.: 14/578,006

(22) Filed: Dec. 19, 2014

(30) Foreign Application Priority Data
Jan. 6, 2014 (JP) 2014-000535

(51) Int. Cl. B60B 27/00

(52) U.S. Cl. CPC B60B 27/0005; B60B 27/0094

(57) ABSTRACT

In a hub unit of a bearing module, an outer end face of an attachment flange of an outer ring in a vehicle lateral direction is located further outward in the vehicle lateral direction than a point of a load applied to the outer ring from rolling elements located on an outer side in the vehicle lateral direction. A fitting surface for determining a radial position of the outer ring with respect to an inner periphery defining a supporting hole is formed on an outer periphery of an insertion portion. An inner edge of the fitting surface in the vehicle lateral direction is located further inward in the vehicle lateral direction than a point of a load applied to the outer ring from the rolling elements located on an inner side in the vehicle lateral direction.

### INCORPORATION BY REFERENCE

The disclosure of Japanese Patent Application No. 2014-000535 filed on Jan. 6, 2014 including the specification, drawings and abstract, is incorporated herein by reference in its entirety.

### BACKGROUND OF THE INVENTION

1. Field of the Invention

The invention relates to a bearing module for rotatably attaching a wheel to a vehicle body of a vehicle such as an automobile.

2. Description of Related Art

As a device for rotatably attaching a wheel to a vehicle body of a vehicle such as an automobile, for example, there has been known a bearing module that includes a knuckle forming a part of a suspension, and a hub unit attached to the knuckle and having a wheel fixed thereto (for example, see Japanese Patent Application Publication No. 2011-94728 (JP 2011-94728 A)). FIG. 6 is a cross-sectional view showing an example of a conventional bearing module. FIG. 7 is a partial enlarged view of FIG. 6. As shown in FIGS. 6 and 7, a bearing module 31 includes a knuckle 32 having a hub unit supporting hole 32a, and a hub unit 34. A wheel 33 and a brake rotor 44 that are wheel-side components are attached to the hub unit 34. In FIGS. 6 and 7, a side on which the wheel is attached (the right side in FIGS. 6 and 7) is an outer side in a vehicle lateral direction, and a center side of the vehicle body (the left side in FIGS. 6 and 7) is an inner side in the vehicle lateral direction. In addition, in FIGS. 6 and 7, an upper side of each figure is an upper side of the bearing module 31, and a lower side of each figure is a lower side of the bearing module 31.

The hub unit 34 has an outer ring 35, an inner shaft 37, outer balls 38 located on the outer side in the vehicle lateral direction, and inner balls 39 located on the inner side in the vehicle lateral direction. The outer ring 35 has an attachment flange 35a. The inner shaft 37 has a flange portion 37a. The outer balls 38 located on the outer side in the vehicle lateral direction and the inner balls 39 located on the inner side in the vehicle lateral direction are disposed between the outer ring 35 and the inner shaft 37. A part of the outer ring 35, which is located on the inner side in the vehicle lateral direction with respect to the attachment flange 35a, serves as an insertion portion 35b, and the insertion portion 35b is inserted and fitted into the supporting hole 32a of the knuckle 32. The attachment flange 35a is attached to the knuckle 32 by bolts 36. The wheel 33 and the brake rotor 44 are attached to the flange portion 37a.

In the conventional bearing module 31 as shown in FIGS. 6 and 7, the attachment flange 35a is formed at a position inward in the vehicle lateral direction in the outer ring 35. In this configuration, providing the attachment flange 35a can ensure adequate rigidity of an inner part of the outer ring 35 in the vehicle lateral direction. Even if a large load F4 is applied from the inner balls 39 to an upper portion 35c of the inner part of the outer ring 35 in the vehicle lateral direction during cornering of the vehicle, etc., the upper portion 35c is therefore less likely to deform radially outward. The load F4 is applied to the upper portion 35c through a point P4 of the load applied from the inner balls 39 to the outer ring 35. The upper portion 35c means a portion of the inner part of the outer ring 35 in the vehicle lateral direction, which is located on the upper side with respect to a central axis of the outer ring 35.

In the conventional configuration as shown in FIGS. 6 and 7, an outer end face 35a1 of the attachment flange 35a in the vehicle lateral direction is located further inward in the vehicle lateral direction than a point P3 of the load applied from the outer balls 38 to the outer ring 35. Accordingly, an outer part of the outer ring 35 in the vehicle lateral direction has low rigidity. When a large load F3 is applied from the outer balls 38 to an upper portion 35d of the outer part of the outer ring 35 in the vehicle lateral direction, the upper portion 35d is therefore likely to greatly deform radially outward as exaggeratingly shown by an imaginary line in FIG. 7.

As described above, the great deformation of the outer ring 35 adversely affects driving stability of the vehicle and a life of the bearing module 31.

FIG. 8A is a perspective view of an outer ring in JP 2011-94728 A. FIG. 8B is a front view of the outer ring in JP 2011-94728 A. As shown in FIGS. 8A and 8B, the outer ring 51 in JP 2011-94728 A is a modification of the conventional outer ring 35 shown in FIGS. 6 and 7. A plurality of ribs 51b is formed on an outer periphery of an outer part of the outer ring 51 in the vehicle lateral direction at predetermined intervals in the circumferential direction. The ribs 51b extend from the attachment flange 51a toward the outer side in the vehicle lateral direction. Thus, in the outer part of the outer ring 51 in the vehicle lateral direction, regions where the ribs 51b are formed have improved rigidity. However, parts 51e between adjacent ribs 51b have inadequate rigidity. This may not prevent the great deformation of the outer part of the outer ring 51 in the vehicle lateral direction.

### SUMMARY OF THE INVENTION

An object of the invention is to provide a bearing module capable of suppressing deformation of both an outer part of an outer ring in a vehicle lateral direction and an inner part of the outer ring in the vehicle lateral direction.

A bearing module according to an aspect of the invention includes a knuckle having a hub unit supporting hole and a hub unit attached to the knuckle. The hub unit includes: an outer ring having on an outer periphery of the outer ring an attachment flange attached to the knuckle, and having an insertion portion fitted into the supporting hole, the insertion portion being a part of the outer ring, which is located on an inner side in a vehicle lateral direction with respect to the attachment flange; an inner shaft disposed on an inner periphery of the outer ring so as to be concentric with the outer ring and having an axial end portion to which a wheel is attached; and rolling elements in double rows that are disposed so as to be rollable between the outer ring and the inner shaft. An outer end face of the attachment flange in the vehicle lateral direction is located further outward in the vehicle lateral direction than a point of a load applied to the outer ring from the rolling elements located on an outer side in the vehicle lateral direction. A fitting surface for determining a radial position of the outer ring with respect to an inner periphery defining the supporting hole is formed on an outer periphery of the insertion portion. An inner edge of the fitting surface in the vehicle lateral direction is located further inward in the vehicle lateral direction than a point of a load applied to the outer ring from the rolling elements located on the inner side in the vehicle lateral direction.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional view showing a bearing module according to a first embodiment of the invention;

FIG. 2 is a partial enlarged view of FIG. 1;

FIG. 3 is a cross-sectional view showing a part of a bearing module according to a second embodiment of the invention;

FIG. 4 is a cross-sectional view showing a part of a bearing module according to a third embodiment of the invention;

FIG. 5 is a cross-sectional view showing a part of a bearing module according to a fourth embodiment of the invention;

FIG. 6 is a cross-sectional view showing a conventional bearing module;

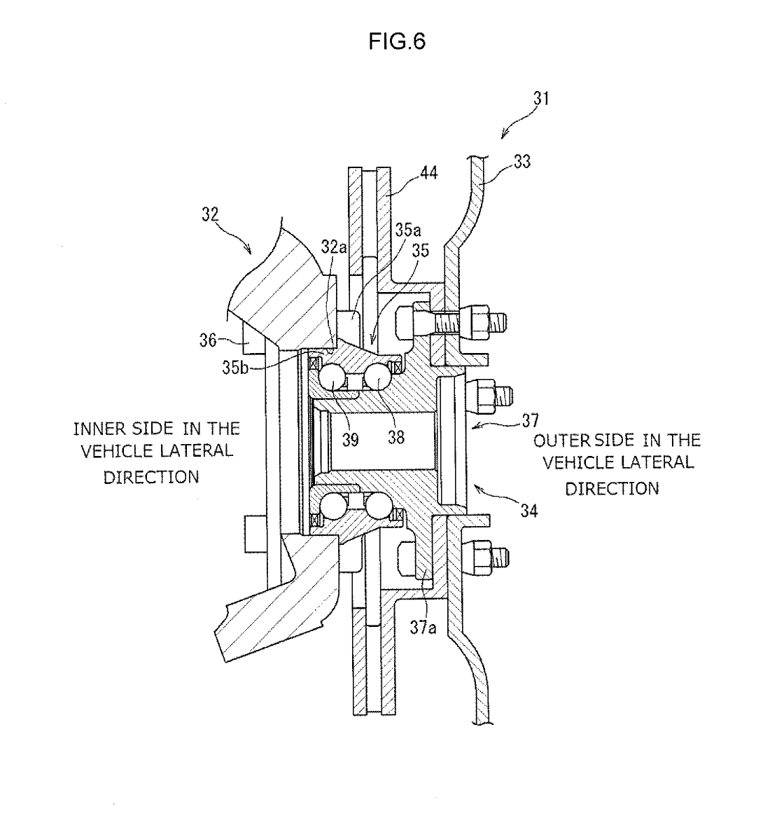

FIG. 7 is a partial enlarged view of FIG. 6;

FIGS. 8A and 8B show a conventional outer ring, FIG. 8A is a perspective view showing the conventional outer ring, and FIG. 8B is a front view showing the conventional outer ring; and

FIG. 9 is a cross-sectional view showing a part of a conventional bearing module different from the conventional bearing module in FIG. 7.

### DETAILED DESCRIPTION OF EMBODIMENTS

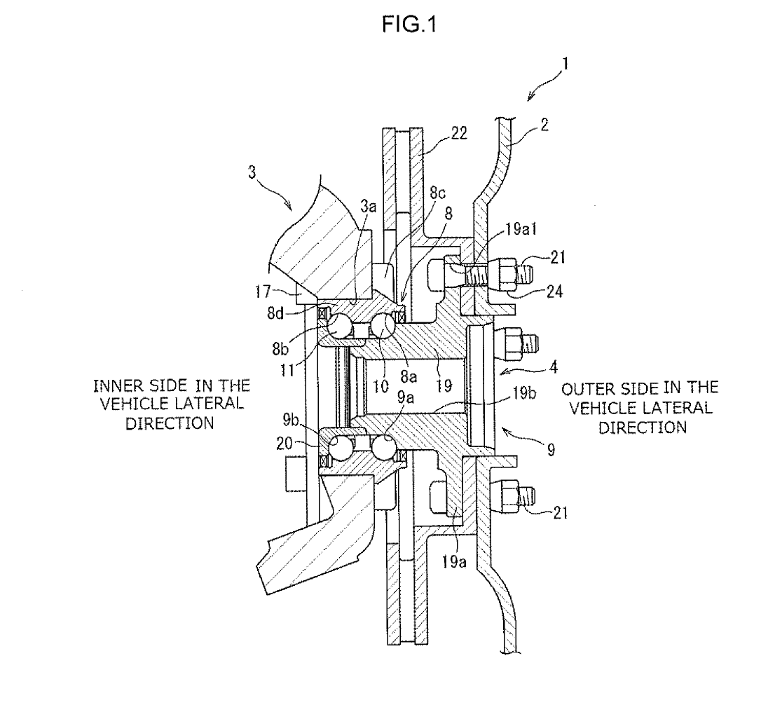

Embodiments of the invention will be described with reference to the accompanying drawings. FIG. 1 is a cross-sectional view showing a bearing module according to a first embodiment of the invention. As shown in FIG. 1, a bearing module 1 is a device for rotatably attaching a wheel serving as a driving wheel to a vehicle body of a vehicle such as an automobile. The bearing module 1 has a knuckle 3 extending from the vehicle body and a hub unit (wheel bearing device) 4. The hub unit 4 is attached to the knuckle 3. A wheel 2 and a brake rotor 22 that are wheel-side components are attached to the hub unit 4. In FIG. 1, a side on which the wheel is attached (the right side in FIG. 1) is an outer side in a vehicle lateral direction, and a center side of the vehicle body (the left side in FIG. 1) is an inner side in the vehicle lateral direction. In FIG, 1, an upper side of the figure is an upper side of the bearing module 1, and a lower side of the figure is a lower side of the bearing module 1.

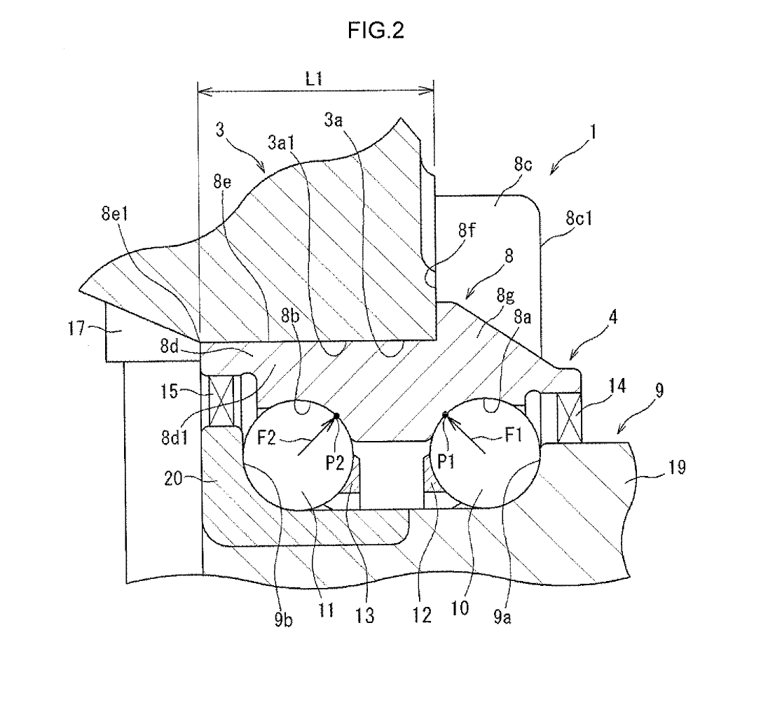

The knuckle 3 forms a part of a suspension. A hub unit supporting hole 3a is formed in a lower part of the knuckle 3 so as to extend in the right and left direction of the vehicle (the right and left direction in FIG. 1). FIG. 2 is a partial enlarged view of FIG. 1. As shown in FIG. 2, the hub unit 4 forms a double-row ball bearing. The hub unit 4 includes an outer ring (hub outer ring) 8, an inner shaft 9, balls (rolling elements) 10, 11 arranged in double rows, cages 12, 13, and seal members 14, 15. The outer ring 8 is fixed to the knuckle 3. The inner shaft 9 is disposed on an inner periphery of the outer ring 8 so as to be concentric with the outer ring 8. The balls 10, 11 arranged in double rows are disposed so as to be rollable between the outer ring 8 and the inner shaft 9. The cages 12, 13 retain the balls 10, 11 arranged in rows, respectively. The seal members 14, 15 seal the opposite ends of an annular clearance between the outer ring 8 and inner shaft 9.

The outer ring 8 is a fixed ring that is fixed to a vehicle body-side member. An outer-side outer ring raceway 8a located on the outer side in the vehicle lateral direction and an inner-side outer ring raceway 8b located on the inner side in the vehicle lateral direction are formed on the inner periphery of the outer ring 8 so as to be arranged along an axial direction. An attachment flange 8c is formed on an outer periphery of the outer ring 8. An inner side face of the attachment flange 8c in the vehicle lateral direction serves as a knuckle attachment surface 8f. The knuckle attachment surface 8f of the attachment flange 8c is attached to an outer side face of the knuckle 3 in the vehicle lateral direction by attachment bolts 17. A part of the outer ring 8, which is located on the inner side in the vehicle lateral direction with respect to the attachment flange 8c, serves as a cylindrical insertion portion 8d. The insertion portion 8d is inserted and fitted into the supporting hole 3a of the knuckle 3. A substantially entire outer periphery of the insertion portion 8d serves as a fitting surface 8e fitted to a substantially entire inner periphery 3a1 defining the supporting hole 3a.

In the first embodiment, the fitting surface 8e means a region of the outer periphery of the insertion portion 8d, which is press-fitted to the inner periphery 3a1 defining the supporting hole 3a. When the insertion portion 8d is inserted into the supporting hole 3a, the fitting surface 8e is press-fitted to the inner periphery 3a1 defining the supporting hole 3a (fitted to the inner periphery 3a1 by interference fitting) such that a radial position of the outer ring 8 with respect to the inner periphery 3a1 is determined.

The inner shaft 9 has a cylindrical shape extending in the right and left direction of the vehicle. The inner shaft 9 serves as an axel, and the wheel 2 and the brake rotor 22 are attached to the inner shaft 9. The inner shaft 9 forms a rolling ring of the hub unit 4. The inner shaft 9 includes a cylindrical inner shaft body 19 and an annular inner ring member 20. The inner ring member 20 is press-fitted to an inner part of the inner shaft body 19 in the vehicle lateral direction. A flange portion 19a is formed on an outer periphery of an outer end portion of the inner shaft body 19 in the vehicle lateral direction. Bolt holes 19a1 are formed on a periphery of the flange portion 19a at prescribed intervals. The wheel 2 and the brake rotor 22 are attached to fixing bolts 21 that are press-fitted into the bolt holes 19a1. The wheel 2 and the brake rotor 22 are fastened together by nuts 24. An outer-side inner ring raceway 9a that faces the outer-side outer ring raceway 8a of the outer ring 8 is formed on an outer periphery of the inner shaft body 19. An inner-side inner ring raceway 9b that faces the inner-side outer ring raceway 8b of the outer ring 8 is formed on an outer periphery of the inner ring member 20. A shaft portion (not shown), which serves as a drive shaft, of a constant velocity joint coupled to a vehicle-side drive shaft is inserted into a center hole 19b of the inner shaft body 19, and the shaft portion and the inner shaft 9 are connected to so as to be integrally rotatable.

The balls 10, 11 arranged in double rows are formed of the outer balls 10 located on the outer side in the vehicle lateral direction and the inner balls 11 located on the inner side in the vehicle lateral direction. The outer balls 10 are disposed so as to be rollable between the outer-side outer ring raceway 8a of the outer ring 8 and the outer-side inner ring raceway 9a of the inner shaft body 19. The inner balls 11 are disposed so as to be rollable between the inner-side outer ring raceway 8b of the outer ring 8 and the inner-side inner ring raceway 9b of the inner ring member 20.

An outer end face 8c1 of the attachment flange 8c in the vehicle lateral direction is located further outward in the vehicle lateral direction than a point P1 of the load applied from the outer balls 10 to the outer ring 8. The point P1 of the load is a contact point between the outer ball 10 and the outer-side outer ring raceway 8a. The knuckle attachment surface 8f of the attachment flange 8c is located further inward in the vehicle lateral direction than the point P1 of the load. An inner edge 8e1 of the fitting surface 8e in the vehicle lateral direction is located further inward in the vehicle lateral direction than a point P2 of the load applied from the inner balls 11 to the outer ring 8. The point P2 of the load is a contact point between the inner ball 11 and the inner-side outer ring raceway 8b.

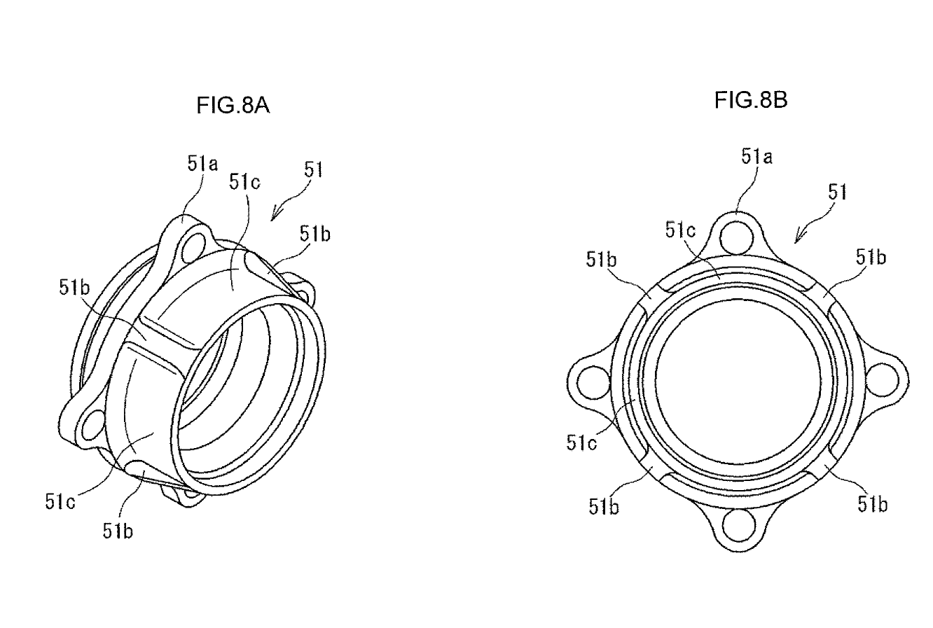

According to the first embodiment, the outer end face 8c1 of the attachment flange 8c in the vehicle lateral direction is located further outward in the vehicle lateral direction than the point P1 of the load applied from the outer balls 10 to the outer ring 8, and the attachment flange 8c is disposed at a position outward in the vehicle lateral direction in the outer ring 8. Providing the attachment flange 8c can therefore increase the rigidity of the outer part of the outer ring 8 in the vehicle lateral direction. In the outer ring 51 described in JP 2011-94728 A, which is shown in FIG. 8, the parts 51c between adjacent ribs 5 lb have inadequate rigidity. On the other hand, in the first embodiment, because the attachment flange 8c is formed over the entire outer periphery of the outer part of the outer ring 8 in the vehicle lateral direction, the entire periphery of the outer part of the outer ring 8 in the vehicle lateral direction can have sufficiently high rigidity.

Even if a large load F1 is applied from the outer balls 10 to an upper portion 8g of the outer part of the outer ring 8 in the vehicle lateral direction through the point P1 of the load during cornering of the vehicle, etc., the radially outward deformation of the upper portion 8g can therefore be suppressed. The upper portion 8g means a portion of the outer part of the outer ring 8 in the vehicle lateral direction, which is located on the upper side with respect to a central axis of the outer ring 8. According to the first embodiment, because the attachment flange 8c is disposed at a position outward in the vehicle lateral direction in the outer ring 8, an inner part of the outer ring 8 in the vehicle lateral direction has low rigidity. When a large load F2 is applied from the inner balls 11 to an upper portion 8d1 of the insertion portion 8d through the contact point P2 during cornering of the vehicle, etc., an inner end portion of the upper portion 8d1 in the vehicle lateral direction may therefore deform radially outward. The upper portion 8d1 means a portion of the insertion portion 8d, which is located on the upper side with respect to a central axis of the insertion portion 8d.

According to the first embodiment, however, the fitting surface 8e of the insertion portion 8d is press-fitted into the supporting hole 3a such that there is no clearance between the fitting surface 8e and the inner periphery 3a1 defining the supporting hole 3a. Even if the large load F2 is applied to the upper portion 8d1 of the insertion portion 8d, the knuckle 3 can therefore reliably receive the load F2 through the fitting surface 8e and the inner periphery 3a1. This can suppress the radially outward large deformation of the upper portion 8d1 of the insertion portion 8d. The substantially entire outer periphery of the insertion portion 8d serves as the fitting surface 8e fitted to the substantially entire inner periphery 3a1 defining the supporting hole 3a. An axial length L1 of the fitting surface 8c in the first embodiment can therefore be increased compared to an axial length of a fitting surface in the case where a part of an outer periphery of an insertion portion serves as a fitting surface, and a contact area between the fitting surface 8e and the inner periphery 3a1 can thus be increased. A contact surface pressure between the fitting surface 8e and the inner periphery 3a1 can be thus reduced compared to a contact surface pressure between a fitting surface and an inner periphery in the case where a part of an outer periphery of an insertion portion serves as a fitting surface. This prevents an excessive force from being applied to the knuckle 3 when the large load F2 is applied to the upper portion 8d1 of the insertion portion 8d.

In addition, because there is no clearance between the fitting surface 8e of the insertion portion 8d and the inner periphery 3a1 defining the supporting hole 3a, a member for filling a clearance is not required. This can reduce the number of components and thus achieve a reduction in cost. In order to install a member for filling a clearance, the outer periphery of the insertion portion 8d, the inner periphery 3a1, etc. are not required to be processed. In addition, because the insertion portion 8d of the outer ring 8 is press-fitted into the supporting hole 3a of the knuckle 3, a fixing force for fixing the outer ring 8 to the knuckle 3 is generated by this press-fitting. This can reduce the number of attachment bolts 17 for fixing the outer ring 8 to the knuckle 3. Compared to a conventional case where the number of attachment bolts 17 is four, for example, the number of attachment bolts 17 can be reduced to two or three.

Furthermore, the insertion portion 8d of the outer ring 8 is press-fitted into the supporting hole 3a of the knuckle 3 such that there is no clearance between the fitting surface 8e of the insertion portion 8d and the inner periphery 3a1 defining the supporting hole 3a. This can improve the rigidity of the hub unit 4 forming a double-row ball bearing.

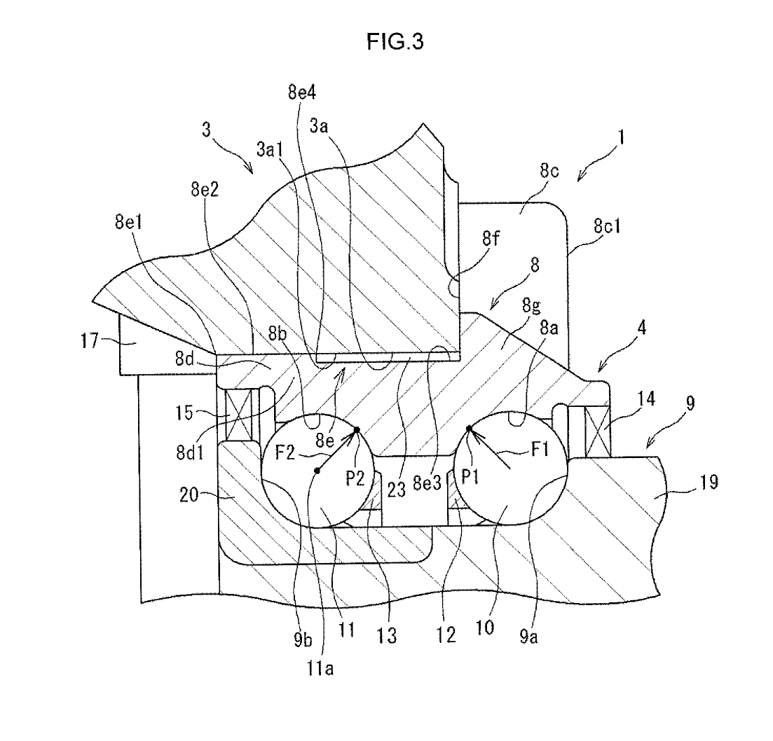

FIG. 3 is a cross-sectional view showing a second embodiment of the invention. This embodiment is a modification of the first embodiment shown in FIGS. 1 and 2. In this embodiment, as shown in FIG. 3, the outer end face 8c1 of the attachment flange 8c in the vehicle lateral direction is located further outward in the vehicle lateral direction than the point P1 of the load applied from the outer balls 10 to the outer ring 8. In a fitting surface 8e of the insertion portion 8d, only an inner region of the fitting surface 8e in the vehicle lateral direction serves as a press-fitting surface 8e2 press-fitted into the supporting hole 3a of the knuckle 3. An outer edge 8e4 of the press-fitting surface 8e2 in the vehicle lateral direction is located, for example, at a position same as or close to a center 11a of the inner ball 11 in an axial direction. A region of the fitting surface 8e, which is located on the outer side in the vehicle lateral direction with respect to the press-fitting surface 8e2, serves as a non-press-fitting surface 8e3 that is not press-fitted into the supporting hole 3a. The non-press-fitting surface 8e3 faces the inner periphery 3a1 defining the supporting hole 3a with an annular clearance 23 that is extremely small (in a radial direction) interposed therebetween. In the following description, the extremely small clearance 23 will be referred to as a fitting clearance. The fitting clearance 23 is, for example, around 0.06 mm. In the second embodiment, the fitting surface 8e means two regions in the outer periphery of the insertion portion 8d, that is, a region that is press-fitted to the inner periphery 3a1 defining the supporting hole 3a and a region that faces the inner periphery 3a1 with the fitting clearance 23 interposed therebetween. When the insertion portion 8d is inserted into the supporting hole 3a, the press-fitting surface 8e2 is press-fitted to the inner periphery 3a1 defining the supporting hole 3a such that a radial position of the outer ring 8 with respect to the inner periphery 3a1 is determined.

In the second embodiment, as in the first embodiment, the outer end face 8c1 of the attachment flange 8c in the vehicle lateral direction is located further outward in the vehicle lateral direction than the point P1 of the load applied from the outer balls 10 to the outer ring 8. Accordingly, providing the attachment flange 8c can increase the rigidity of the outer part of the outer ring 8 in the vehicle lateral direction. Even if the large load F1 is applied from the outer balls 10 to the upper portion 8g of the outer part of the outer ring 8 in the vehicle lateral direction through the point P1 of the load during cornering of the vehicle, etc., the radially outward deformation of the upper portion 8g can therefore be suppressed. The upper portion 8g means a portion of the outer part of the outer ring 8 in the vehicle lateral direction, which is located on the upper side with respect to a central axis of the outer ring 8. In addition, the press-fitting surface 8e2 of the fitting surface 8e of the insertion portion 8d is press-fitted into the supporting hole 3a such that there is no clearance between the press-fitting surface 8e2 and the inner periphery 3a1 defining the supporting hole 3a. Even if the large load F2 is applied to the upper portion 8d1 of the insertion portion 8d, the knuckle 3 can therefore reliably receive the load F2 through the press-fitting surface 8e2 and the inner periphery 3a1. This can suppress the radially outward large deformation of the upper portion 8d1 of the insertion portion 8d. The upper portion 8d1 means a portion of the insertion portion 8d, which is located on the upper side with respect to a central axis of the insertion portion 8d.

Furthermore, only an inner region of the fitting surface 8e in the vehicle lateral direction serves as the press-fitting surface 8e2 and is press-fitted into the supporting hole 3a of the knuckle 3. This can prevent an excessive fixing force generated by press-fitting from being applied from the outer ring 8 to the knuckle 3. The insertion portion 8d can therefore be easily removed from the supporting hole 3a at the time of maintenance of the bearing module 1. In addition, a large force for press-fitting the insertion portion 8d into the supporting hole 3a is not required at the time of assembly of the bearing module 1, and the press-fitting operation can be thus easily performed.

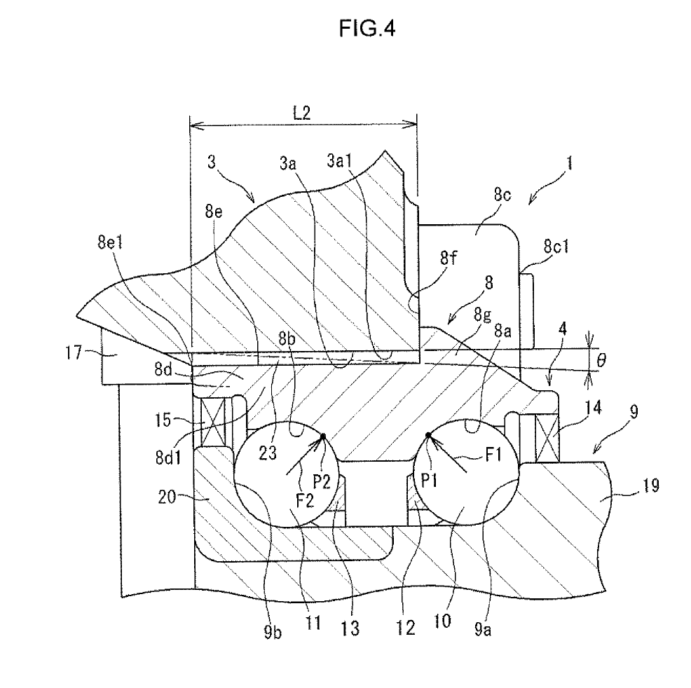

FIG. 4 is a cross-sectional view showing a third embodiment of the invention. In this embodiment, as shown in FIG. 4, the outer end face 8c1 of the attachment flange 8c in the vehicle lateral direction is located further outward in the vehicle lateral direction than the point P1 of the load applied from the outer balls 10 to the outer ring 8. A fitting clearance 23 is formed between an entire fitting surface 8e and the inner periphery 3a1 defining the supporting hole 3a so as to extend along an entire axial length of the fitting surface 8e. The inner edge 8e1 of the fitting surface 8e in the vehicle lateral direction is located further inward in the vehicle lateral direction than the point P2 of the load applied from the inner balls 11 to the outer ring 8. An axial length of the fitting surface 8e is L2. In the third embodiment, the fitting surface 8e means a region of the outer periphery of the insertion portion 8d, which faces the inner periphery 3a1 defining the supporting hole 3a with the fitting clearance 23 interposed therebetween. When the insertion portion 8d is inserted into the supporting hole 3a, the fitting surface 8e is brought into contact with the inner periphery 3a1 defining the supporting hole 3a or is guided by the inner periphery 3a1 such that a radial position of the outer ring 8 with respect to the inner periphery 3a1 is determined. Even with the insertion portion 8d fitted into the supporting hole 3a, a radial position of the outer ring 8 with respect to the inner periphery 3a1 defining the supporting hole 3a can be determined by the fitting surface 8e.

In the third embodiment, as in the first embodiment, the outer end face 8c1 of the attachment flange 8c in the vehicle lateral direction is located further outward in the vehicle lateral direction than the point P1 of the load applied from the outer balls 10 to the outer ring 8. Accordingly, providing the attachment flange 8c can increase the rigidity of the outer part of the outer ring 8 in the vehicle lateral direction. Even if the large load F1 is applied from the outer balls 10 to the upper portion 8g of the outer part of the outer ring 8 in the vehicle lateral direction through the point P1 of the load during cornering of the vehicle, etc., the radially outward deformation of the upper portion 8g can therefore be suppressed. The upper portion 8g means a portion of the outer part of the outer ring 8 in the vehicle lateral direction, which is located on the upper side with respect to a central axis of the outer ring 8. In addition, forming the fitting clearance 23 can facilitate insertion and fitting of the insertion portion 8d into the supporting hole 3a at the time of assembly of the bearing module 1 and also facilitate removal of the insertion portion 8d from the supporting hole 3a at the time of maintenance of the bearing module 1. When the insertion portion 8d is inserted into the supporting hole 3a, a jig for assisting this insertion may be used. In the case where the fitting clearance 23 is formed between the entire fitting surface 8e and the inner periphery 3a1 defining the supporting hole 3a, and the large load F2 is applied from the inner balls 11 to the upper portion 8d1 of the insertion portion 8d, the upper portion 8d1 may largely deform radially outward. It will be described next that such large deformation does not occur in the third embodiment, compared to the conventional bearing module. The upper portion 8d1 means a portion of the insertion portion 8d, which is located on the upper side with respect to a central axis of the insertion portion 8d.

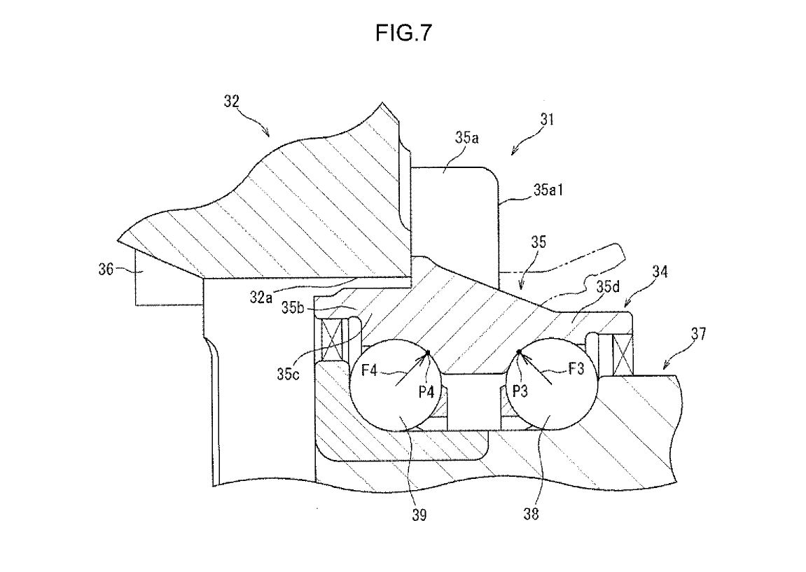

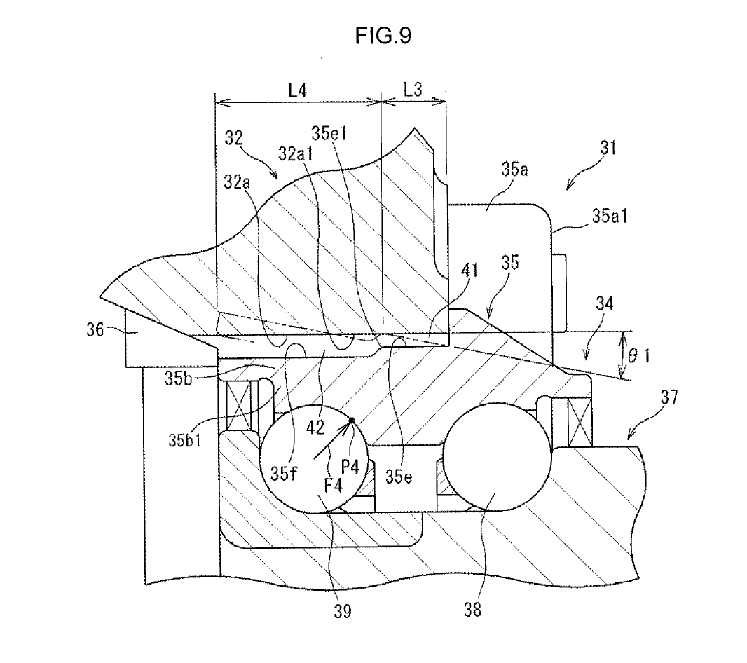

FIG. 9 is a cross-sectional view showing a part of a conventional bearing module different from the conventional bearing module in FIG. 7. In a conventional bearing module 31 shown in FIG. 9, as in the third embodiment, an attachment flange 35a is formed at a position outward in the vehicle lateral direction in an outer periphery of an outer ring 35. In an outer periphery of an insertion portion 35b of the outer ring 35, only an outer region of the outer periphery in the vehicle lateral direction serves as a fitting surface 35e that faces an outer region of an inner periphery 32a1 defining a supporting hole 32a in the vehicle lateral direction with a fitting clearance 41 whose radial length is extremely small interposed therebetween. In the description of this conventional example, the fitting surface 35e means a region of the outer periphery of the insertion portion 35b, which faces the inner periphery 32a1 defining the supporting hole 32a with the fitting clearance 41 interposed therebetween. An inner edge 35e1 of the fitting surface 35e in the vehicle lateral direction is located further outward in the vehicle lateral direction than a point P4 of the load applied from the inner balls 39 to the outer ring 35.

A region of the outer periphery of the insertion portion 35b, which is located on the inner side in the vehicle lateral direction with respect to the fitting surface 35e, serves as a non-fitting surface 35f that faces the inner periphery 32a1 defining the supporting hole 32a with an annular clearance 42 larger than the fitting clearance 41 interposed therebetween. The non-fitting surface 35f means a region of the outer periphery of the insertion portion 35b, which faces the inner periphery 32a1 defining the supporting hole 32a with the annular clearance 42 larger than the fitting clearance 41 interposed therebetween. With the insertion portion 35b fitted into the supporting hole 32a, the non-fitting surface 35f therefore has no function of determining a radial position of the outer ring 35 with respect to the inner periphery 32a1 defining the supporting hole 32a.

According to the conventional configuration shown in FIG. 9, in the outer periphery of the insertion portion 35b, only the outer region of the outer periphery in the vehicle lateral direction serves as the fitting surface 35e, and the inner edge 35e1 of the fitting surface 35e in the vehicle lateral direction is located further outward in the vehicle lateral direction than the point P4 of the load applied from the inner balls 39 to the outer ring 35. In the conventional configuration shown in FIG. 9, as exaggeratingly shown by an imaginary line in FIG. 9, an outer periphery of an upper portion 35b1 is therefore brought into contact with the inner periphery 32a1 defining the supporting hole 32a by largely deforming radially outward the upper portion 35b1 of the insertion portion 35b. In other words, the radially outward large deformation of the upper portion 35b1 is permitted. The upper portion 35b1 means a portion of the insertion portion 35b, which is located on the upper side with respect to a central axis of the insertion portion 35b. When the large load F4 is applied from the inner balls 39 to the upper portion 35b1 of the insertion portion 35b during cornering of the vehicle, etc., the upper portion 35b1 may therefore largely deform radially outward. In addition, a deformation angle θ1 between a position of the upper portion 35b1 before deformation shown by a continuous line and a position of the upper portion 35b1 after deformation shown in by an imaginary line is increased.

On the other hand, in the third embodiment, the substantially entire outer periphery of the insertion portion 8d serves as the fitting surface 8e, the fitting surface 8e faces the substantially entire inner periphery 3a1 defining the supporting hole 3a, and the inner edge 8e1 of the fitting surface 8e in the vehicle lateral direction is located further inward in the vehicle lateral direction than the point P2 of the load applied from the inner balls 11 to the outer ring 8. Accordingly, as shown by an imaginary line in FIG. 4, the outer periphery (the fitting surface 8e) of the upper portion 8d1 is brought into contact with the inner periphery 3a1 defining the supporting hole 3a without largely deforming radially outward the upper portion 8d1 of the insertion portion 8d.

In other words, the radially outward large deformation of the upper portion 8d1 of the insertion portion 8d is suppressed. Even if the large load F2 is applied from the inner balls 11 to the upper portion 8d1 of the insertion portion 8d during cornering of the vehicle, etc., the radially outward large deformation of the upper portion 8d1 can therefore be suppressed. Even if the upper portion 8d1 deforms, a deformation angle θ (see FIG. 4) between a position of the upper portion 8d1 before deformation shown by a continuous line and a position of the upper portion 8d1 after deformation shown by the imaginary line is smaller than the conventional deformation angle θ1 shown in FIG. 9. In the conventional configuration shown in FIG. 9, an axial length L3 of the fitting surface 35e is shorter than the axial length L2 of the fitting surface 8e in this embodiment, and an axial length L4 of the non-fitting surface 35f is longer than the axial length L3 of the fitting surface 35e.

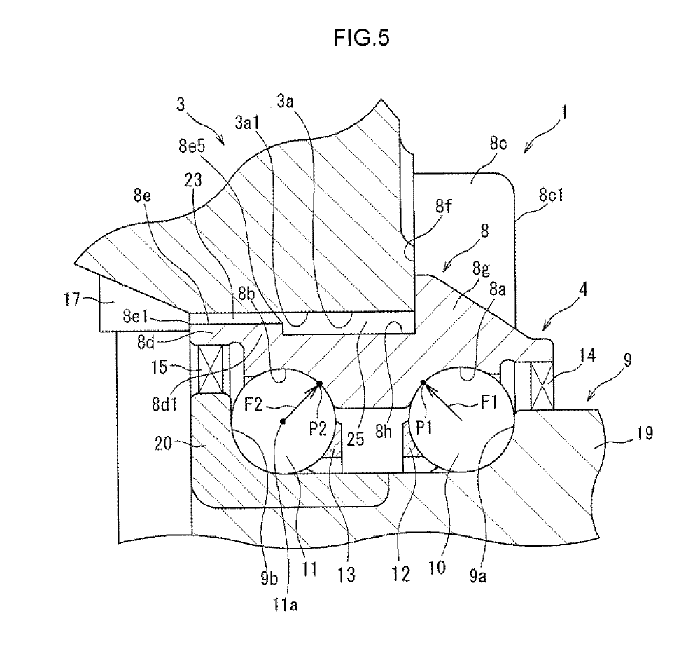

FIG. 5 is a cross-sectional view showing a fourth embodiment of the invention. This embodiment is a modification of the third embodiment shown in FIG. 4. In this embodiment, as shown in FIG. 5, the outer end face 8c1 of the attachment flange 8c in the vehicle lateral direction is located further outward in the vehicle lateral direction than the point P1 of the load applied from the outer balls 10 to the outer ring 8. Only an inner region of the outer periphery of the insertion portion 8d in the vehicle lateral direction serves as the fitting surface 8e that faces the inner periphery 3a1 defining the supporting hole 3a with an annular fitting clearance 23 (extending in the radial direction) interposed therebetween. The inner edge 8e1 of the fitting surface 8e in the vehicle lateral direction is located further inward in the vehicle lateral direction than the point P2 of the load applied from the inner balls 11 to the outer ring 8. An outer edge 8e5 of the fitting surface 8e in the vehicle lateral direction is located, for example, at a position same as or close to the center 11a of the inner ball 11 in an axial direction. In the fourth embodiment, the fitting surface 8e means a region of the outer periphery of the insertion portion 8d, which faces the inner periphery 3a1 defining the supporting hole 3a with the fitting clearance 23 interposed therebetween. When the insertion portion 8d is inserted into the supporting hole 3a, the fitting surface 8e is brought into contact with the inner periphery 3a1 defining the supporting hole 3a or is guided by the inner periphery 3a1 such that a radial position of the outer ring 8 with respect to the inner periphery 3a1 is determined. Even with the insertion portion 8d fitted into the supporting hole 3a, the radial position of the outer ring 8 with respect to the inner periphery 3a1 defining the supporting hole 3a is determined by the fitting surface 8e. A region of the outer periphery of the insertion portion 8d, which is located on the outer side in the vehicle lateral direction with respect to the fitting surface 8e, serves as a non-fitting surface 8h that faces the inner periphery 3a1 defining the supporting hole 3a with an annular clearance 25 larger than the fitting clearance 23 interposed therebetween. In the fourth embodiment, the non-fitting surface 8h means a region of the outer periphery of the insertion portion 8d, which faces the inner periphery 3a1 defining the supporting hole 3a with the annular clearance 25 larger than the fitting clearance 23 interposed therebetween. With the insertion portion 8d fitted into the supporting hole 3a, the non-fitting surface 8h therefore has no function of determining the radial position of the outer ring 8 with respect to the inner periphery 3a1 defining the supporting hole 3a.

In the fourth embodiment, as in the third embodiment, the outer end face 8c1 of the attachment flange 8c in the vehicle lateral direction is located further outward in the vehicle lateral direction than the point P1 of the load applied to from the outer balls 10 to the outer ring 8. Accordingly, providing the attachment flange 8c can increase the rigidity of the outer part of the outer ring 8 in the vehicle lateral direction. Even if the large load Fl is applied from the outer balls 10 to the upper portion 8g of the outer part of the outer ring 8 in the vehicle lateral direction through the point P1 of the load during cornering of the vehicle, etc., the radially outward deformation of the upper portion 8g can therefore be suppressed. The upper portion 8g means a portion of the outer part of the outer ring 8 in the vehicle lateral direction, which is located on the upper side with respect to a central axis of the outer ring 8.

In addition, the inner region of the outer periphery of the insertion portion 8d in the vehicle lateral direction serves as the fitting surface 8e and the fitting surface 8e faces the region of the inner periphery 3a1 defining the supporting hole 3a, which is located on the inner side in the vehicle lateral direction. The inner edge 8e1 of the fitting surface 8e in the vehicle lateral direction is located further inward in the vehicle lateral direction than the point P2 of the load applied from the inner balls 11 to the outer ring 8. Accordingly, the outer periphery (the fitting surface 8e) of the upper portion 8d1 is brought into contact with the inner periphery 3a1 defining the supporting hole 3a without largely deforming radially outward the upper portion 8d1 of the insertion portion 8d. In other words, the radially outward large deformation of the upper portion 8d1 of the insertion portion 8d is suppressed. The upper portion 8d1 means a portion of the insertion portion 8d, which is located on the upper side with respect to a central axis of the insertion portion 8d. Even if the large load F2 is applied from the inner balls 11 to the upper portion 8d1 of the insertion portion 8d during cornering of the vehicle, etc., the radially outward large deformation of the upper portion 8d1 can therefore be suppressed.

Furthermore, forming the fitting clearance 23 and the annular clearance 25 can facilitate insertion and fitting of the insertion portion 8d into the supporting hole 3a at the time of assembly of the bearing module 1 and also facilitate removal of the insertion portion 8d from the supporting hole 3a at the time of maintenance of the bearing module 1. In addition, the fitting surface 8e is formed by machining the outer periphery of the insertion portion 8d. An axial length of the fitting surface 8e in the fourth embodiment is smaller than an axis length of the fitting surface 8e in the third embodiment. The fitting surface 8e in the fourth embodiment can therefore be easily formed compared to the fitting surface 8e in the third embodiment.

In the above embodiments, a ball is used as a rolling element, and however, a tapered roller may be used as a rolling element.

According to a bearing module of the invention, deformation of both an outer part of an outer ring in the vehicle lateral direction and an inner part of an outer ring in the vehicle lateral direction can be suppressed.

What is claimed is:

1. A bearing module comprising:
a knuckle having a hub unit supporting hole; and
a hub unit attached to the knuckle,
the hub unit including
an outer ring having on an outer periphery of the outer ring an attachment flange attached to the knuckle, and having an insertion portion fitted into the supporting hole, the insertion portion being a part of the outer ring, which is located in an inner side in a vehicle lateral direction with respect to the attachment flange,
an inner shaft disposed on an inner periphery of the outer ring so as to be concentric with the outer ring and having an axial end portion to which a wheel is attached, and
rolling elements in double rows that are disposed so as to be rollable between the outer ring and the inner shaft, wherein
an outer end face of the attachment flange in the vehicle lateral direction is located further outward in the vehicle lateral direction than a point of a load applied to the outer ring from the rolling elements located on an outer side in the vehicle lateral direction,
a fitting surface for determining a radial position of the outer ring with respect to an inner periphery defining the supporting hole is formed on an outer periphery of the insertion portion, and
an inner edge of the fitting surface in the vehicle lateral direction is located further inward in the vehicle lateral direction than a point of a load applied to the outer ring from the rolling elements located on the inner side in the vehicle lateral direction.

2. The bearing module according to claim 1, wherein
the fitting surface of the insertion portion is press-fitted into the supporting hole.

3. The bearing module according to claim 1, wherein
a fitting clearance is formed between the fitting surface and the inner periphery defining the supporting hole.
